(19) United States
(12) Patent Application Publication
(10) Pub. No.: US 2025/0142447 A1
(43) Pub. Date: May 1, 2025

(54) METHOD FOR DETERMINISTIC CLUSTER BASED ROUTING IN WIRELESS SENSOR NETWORKS

(71) Applicant: UNIVERSITY OF SEOUL INDUSTRY COOPERATION FOUNDATION, Seoul (KR)

(72) Inventor: Sang Hyuk KANG, Seoul (KR)

(21) Appl. No.: 18/922,329

(22) Filed: Oct. 21, 2024

(30) Foreign Application Priority Data
Oct. 25, 2023 (KR) 10-2023-0144038

(51) Int. Cl. H04W 40/32; H04W 40/38; H04W 84/18

(52) U.S. Cl. CPC H04W 40/32; H04W 40/38; H04W 84/18

(57) ABSTRACT

The present invention presents a location-based deterministic cluster routing technology that improves energy efficiency in wireless sensor networks. Existing random cluster-based routing technologies allocate the number of clusters and nodes for each round based on probability, but this random algorithm requires unnecessary messages and causes inefficient load balancing. On the other hand, the present invention proposes optimal routing between the head node and the sensing nodes for K clusters for each round by specifying the location of the sensing nodes. As a result, it is possible to innovate load balancing and at the same time extend network lifespan, thereby providing superior competitiveness, compared to existing technologies.

### CROSS REFERENCE TO RELATED APPLICATION

The present application claims priority to Korean Patent Application No. 10-2023-0144038, filed on Oct. 25, 2023, the entire contents of which is incorporated herein for all purposes by this reference.

### FIELD OF THE INVENTION

Disclosed embodiments relate to a method for deterministic cluster-based routing in wireless sensor networks. Specifically, disclosed embodiments relate to location-based deterministic cluster-based routing technology which improves energy efficiency in wireless sensor networks by equally dividing clusters based on the calculated location information of all nodes and implementing an optimal communication path therefrom.

### BACKGROUND

Wireless sensor networks (WSN) obtain target information from data transmitted by multiple nodes in a sensor field. Since a battery powers each node, the energy for data transmission must be minimized.

Some studies propose cluster-based hierarchical routing technology, e.g., a low energy adaptive clustering hierarchy (LEACH) protocol, as an energy-saving routing method to solve the above problem.

In the LEACH protocol, when sensor nodes in each cluster transmit measurement data to cluster heads for each round, cluster nodes merge the received measurement data and transmit the same to a base station.

In the LEACH protocol, the number of clusters corresponds to a random variable that may vary for each round. Additionally, the number of sensor nodes clustered for each round is also determined randomly.

As such, the irregular number of clusters and nodes for each round requires unnecessary messages and causes inefficient load balancing. Ultimately, the probabilistic cluster routing increases energy consumption.

That is, despite recent research in the field of wireless sensor networks, there is still a need for a more energy-efficient routing method by eliminating the irregularity caused by the random operation.

### Prior Art Document

Patent 1: Korean Patent Publication No. 10-1780144 (on Sep. 19, 2017)

### DETAILED DESCRIPTION OF THE INVENTION

### Technical Problem

Disclosed embodiments for implementing deterministic cluster-based routing in wireless sensor networks provide a method for location-based deterministic cluster-based routing which improves energy efficiency in wireless sensor networks to achieve a high level of load equalization by omitting unnecessary control messages and keeping the number of clusters and the number of nodes in the cluster constant for each round.

### Solution to Problem

Exemplary embodiments of the present invention provide a method for deterministic cluster-based routing in wireless sensor networks. The method, performed by a computing device for routing in cluster-based wireless sensor networks, comprises the steps of broadcasting, by each of all nodes including a plurality of sensor nodes and a base station node, to the other nodes than each node to obtain the reception strength of the message received by each node, calculating distance information between a transmission node and a reception node of the message based on the reception strength of the message and the transmission strength of the message, determining a plurality of reference nodes among all nodes in a sensor field of the wireless sensor networks based on the distance information, calculating coordinates of the other nodes through the distance information between the plurality of reference nodes and the distance information to at least one of the plurality of reference nodes, and allocating each of the plurality of sensor nodes to a preset number of clusters.

### Effect of the Invention

According to the disclosed embodiments, the locations of all nodes may be calculated from the reference nodes in the circular sensor field determined based on the reception strength of the message.

According to the disclosed embodiments, the unnecessary control messages may be omitted by determining the head node and the transmission order based on the index given based on the coordinates of sensor nodes.

According to the disclosed embodiments, a high level of load equalization may be achieved by keeping the number of clusters and the transmission order of nodes in the cluster constant for each round.

### BRIEF DESCRIPTION OF THE DRAWINGS

FIG. 1 is a diagram showing a routing protocol for traditional cluster-based wireless sensor networks.

FIG. 2 is a block diagram of a computing device that performs a method for deterministic cluster-based routing in wireless sensor networks, according to an embodiment.

FIG. 3 is an example diagram illustrating the process of calculating the coordinates of all nodes for routing, according to the present invention.

FIG. 4 is an example diagram illustrating the clustering process for routing, according to the present invention.

FIG. 5 is a graph comparing performances of methods for routing in wireless sensor networks, according to an embodiment.

FIG. 6 is a flowchart of a method for deterministic cluster-based routing in wireless sensor networks, according to an embodiment.

### DETAILED DESCRIPTION OF THE INVENTION

### Term Definition

In this specification, a deterministic cluster-based wireless sensor network may refer to a network that performs optimal routing without random variables while calculating the coordinates of all nodes in the sensor field.

In this specification, a plurality of reference nodes used to calculate the coordinates of all nodes are assumed to be located near the boundary of the sensor field.

In this specification, a first reference node may refer to a node corresponding to a base station node. In this specification, a second reference node may refer to a reference node for determining the diameter of the sensor field. In this specification, a third reference node may refer to a reference node for determining the location of the circular sensor field.

The terms “first”, “second”, and the like are only used to distinguish various components and are not limited by the terms.

In this specification, the following symbols may be defined as in Table 1.

TABLE 1

| | |
|---|---|
| N | number of sensor nodes |
| K | number of clusters |
| G | number of nodes in cluster |
| 2L | diameter of circular sensor field |
| P_{g} | transmission strength of message |
| Pᵣ | reception strength of message |
| n₀ | first reference node |
| n_{f} | second reference node |
| nᵥ | third reference node |
| nᵢ | sensor node corresponding to index i (hereinafter, referred |
| | to as i^{th} sensor node) |
| d_{i, j} | distance between i^{th} node and j^{th} node according to signal |
| | size of message |

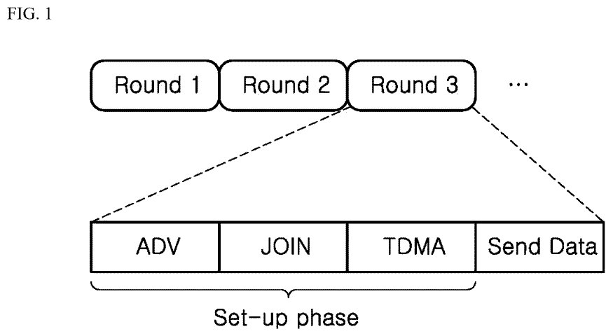

FIG. 1 is a diagram showing a routing protocol for traditional cluster-based wireless sensor networks. Referring to FIG. 1, the cluster-based wireless sensor network performs a setup phase for each round.

Specifically, the setup phase requires a step of broadcasting, by nodes that have become cluster heads randomly in that round, an advertising message to announce that the nodes are head nodes (ADV). Thereafter, the setup phase requires a step of transmitting, by non-head nodes, a join message to join one of the clusters (JOIN). Finally, the setup phase requires a step of transmitting, by the head nodes, TDMA messages to specify time slots for sensor nodes in each cluster (TDMA).

The setup phase is an essential step for collecting information, performed before the sensor nodes transmit the received information. If the setup phase is omitted in the cluster-based wireless sensor networks, the protocol can be energy-efficient.

However, the setup phase occurs when the order of the time slots for the head nodes and the non-head nodes is not specified. Thus, there is a need for eliminating the setup phase.

### Description of Exemplary Embodiments of the Present Invention

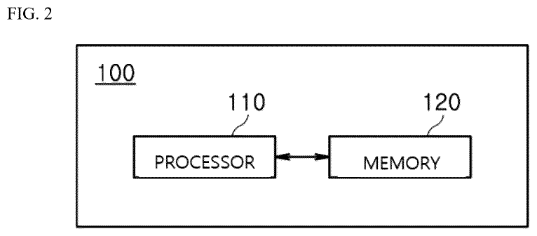

FIG. 2 is a block diagram of a computing device 100 that performs a method for deterministic cluster-based routing in wireless sensor networks, according to an embodiment.

Referring to FIG. 2, the computing device 100 includes a processor 110 and memory 120.

The processor 110 performs routing in deterministic cluster-based wireless sensor networks.

First, the processor 110 acquires the reception strength of the message received by each node by broadcasting to the other nodes than each node, including a plurality of sensor nodes and a base station node.

The transmission strength of the message broadcast by each node to the other nodes than each node may be the same. As a specific example, the transmission strength of the message which is a preset value may be defined as a transmission strength P_{g} corresponding to a transmission distance 2L. It is desirable that message collisions are prevented using technologies, such as CSMA/CA.

The message, which is a message in bit units, may consume as much energy as E_{T}(l, d) when transmitting 1-bit.

Specifically, E_{T}(l, d) may be defined as in Equation 1 below:

$${E}_{T} ( l , d ) = \{ \begin{matrix}l ( {E}_{e} + {ε}_{f} {d}^{2} ) , & d < δ \\ l ( {E}_{e} + {ε}_{m} {d}^{4} ) , & d \geq δ\end{matrix} \qquad [ Equation 1 ]$$

E_{T}(l, d) may refer to an amount of energy consumed by sensor nodes when transmitting an 1-bit message at distance d, and Eₑ, ε_{f}, εₘ, and δ may each refer to a random real number.

Preferably, Eₑ, which is an energy for each bit within a circuit, may be 50 [nJ/bit].

Preferably, ε_{f}, which is an energy attenuation coefficient in a free space model, may be 10 [pJ/bit/m²].

Preferably, εₘ, which is an energy attenuation coefficient in a multipath model, may be 0.0013 [pJ/bit/m⁴].

Preferably, δ, which is a value corresponding to \sqrt{ε_{f}/εₘ} and is a boundary value for changing from the free space model to the multipath model, may be about 87.7 [m].

The node that receives the message and the node that transmits the message are assumed to have symmetrical channels. In other words, for convenience of calculation, it is desirable to assume that the signal strength is the same even when the message is transmitted in the reverse direction.

The processor 110 calculates distance information between the transmission node and the reception node of the message based on the reception strength and the transmission strength of the message.

That is, the processor 110 may calculate the distance information between the transmission node and the reception node of the message based on the transmission strength of the message with a preset value and the reception strength of the obtained message.

The processor 110 may obtain the reception strength of the message between all nodes by reporting the reception strength of the message received by each node from other nodes. The reception strength of the message is referred to as Pᵣ.

Specifically, the processor 110 may use the reception strength of the message to calculate the distance information between the transmission node and the reception node of the message as shown in Equation 2 below:

$${d}_{i , j} = \{ \begin{matrix}\sqrt{\frac{{P}_{g}}{{ε}_{f} {P}_{r}} ,} & {P}_{r} \geq \frac{{P}_{g}}{{ε}_{f} {δ}^{2}} \\ \sqrt[4]{\frac{{P}_{g}}{{ε}_{m} {P}_{r}}} , & {P}_{r} < \frac{{P}_{g}}{{ε}_{f} {δ}^{2}}\end{matrix} \qquad [ Equation 2 ]$$

d_{i,j} may refer to a distance between the i^{th} node and the j^{th} node that transmit and receive the message and Pᵣ may refer to a reception strength of the message at the i^{th} node or j^{th} node. For convenience of explanation, overlapping descriptions will be omitted.

The processor 110 may determine a plurality of reference nodes among all nodes in the sensor field of the wireless sensor networks, based on the distance information.

The processor 110 may determine two nodes with the greatest distance among the distance information as a first reference node and a second reference node of the plurality of reference nodes.

In other words, the processor 110 may denote the first reference node as n0 and determine coordinates that meet the conditions of Equation 3 below as the coordinates of the second reference node:

$${n}_{f} ; f = arg {max}_{i} ( {d}_{o , i} ) \qquad [ Equation 3 ]$$

n_{f} may refer to the second reference node. When the distance between the i^{th} sensor node and the first reference node n0 becomes the maximum and the distance is d_{o,i}, the index i may be referred to as the index (f) of the second reference node.

The processor 110 may determine a node, closest to the circular boundary of which the diameter is a first distance between the first reference node and the second reference node of the plurality of reference nodes and the center is a midpoint of the first distance, as the third reference node.

Specifically, the processor 110 may determine coordinates that meet the conditions of Equation 4 below as the coordinates of the third reference node.

$${n}_{v} ; v = arg {max}_{i} ( {d}_{o , i}^{2} + {d}_{f , i}^{2} )$$

nᵥ may refer to the third reference node. When the i^{th} sensor node has the maximum sum of the Euclidean distances (d_{f,i}) to the first reference node (d_{o,i}) and to the second reference nod, the index i may be referred to as the index (v) of the third reference node.

Specifically, the processor 110 may calculate the coordinates of the third reference node based on Equation 4 below:

$$\{ \begin{matrix}{x}_{v} & = L \pm \sqrt{{d}_{0 , v}^{2} - \frac{{d}_{0 , v}^{4}}{4 {L}^{2}}} \\ {y}_{v} & = 2 L - \frac{{d}_{0 , v}^{2}}{2 L}\end{matrix} \qquad [ Equation 4 ]$$

xᵥ and xᵥ are the coordinates of the third reference node, 2L is the first distance, and d_{o,v} is the distance between the first reference node and the third reference node.

According to Equation 4, there may be a plurality of third reference nodes with a finite number of significant digits in calculations. The processor 110 may first assume any one of the two values as the coordinates of the third reference node and may correct the one to the other value to eliminate the coordinate uncertainty of the third reference node when a contradiction occurs in the coordinate calculation of the other nodes.

The processor 110 may define the boundary of the sensor field as the circular boundary of the field determined based on the first, second, and third reference nodes.

The processor 110 calculates the coordinates of the other nodes through distance information between the plurality of reference nodes and distance information to at least one of the plurality of reference nodes.

Specifically, the processor 110 may calculate the coordinates of the other nodes based on triangulation with the plurality of reference nodes.

Specifically, the processor 110 may calculate the coordinates (xi, yi) of the other nodes from the distance between the first and second reference nodes, based on Equation 5 below:

$$\{ \begin{matrix}{x}_{i} & = L \pm \sqrt{{d}_{f , i}^{2} - ( \frac{{d}_{f , i}^{2} - {d}_{0 , i}^{2}}{4 L} + L )} \\ {y}_{i} & = \frac{{d}_{f , i}^{2} - {d}_{0 , i}^{2}}{4 L} + L\end{matrix} \qquad [ Equation 5 ]$$

xᵢ and yᵢ are the coordinates of the node corresponding to index i (hereinafter, referred to as the i^{th} node), 2L is the first distance, d_{0,i} is the distance between the first reference node and the i^{th} node, and d_{f,i} is the distance between the second reference node and the i^{th} node.

The xᵢ coordinates are displayed as plus (+) and minus (−), wherein the xᵢ coordinates may be calculated precisely from the distance to the third reference node, according to Equation 7.

The processor 110 allocates the plurality of sensor nodes to a preset number of clusters, wherein it is desirable that the number of clusters is a constant value given for each round.

The processor 110 may give a new index to the sensor nodes based on the coordinates of the sensor nodes. The processor 110 may allocate the plurality of sensor nodes to the cluster based on the new index.

The processor 110 may specify the order of time slots for the sensor nodes.

The processor 110 may specify the order of time slots for the sensor nodes based on the new index given to the sensor nodes. For example, the processor 110 may sequentially specify the time slots for the sensor nodes based on the index order or the reverse order.

The processor 110 may specify a head node within the cluster for each round.

For each round, the processor 110 may determine the head node within each cluster to be any one of the sensor nodes included in each cluster based on Equation 6 below:

$$H = ( k - 1 ) G + ( r - 1 ) \% G + 1 + \qquad [ Equation 6 ]$$

H may be an index of a node corresponding to the head node, k may be a cluster number, G may be the number of sensor nodes in the cluster, and r may be a round number.

The memory 120 stores one or more instructions executed by the processor 110.

The memory 120 may store various data used by the processor 110. For example, the memory 120 may include input data or output data for software (e.g., a program executed by the processor 110 and/or instructions related to the program).

In FIG. 2, it is described that the method is performed by a computing device but this is only an example. Entities capable of performing routing in wireless sensor networks, such as a sink node or a base station node, are included therein but are not necessarily limited thereto.

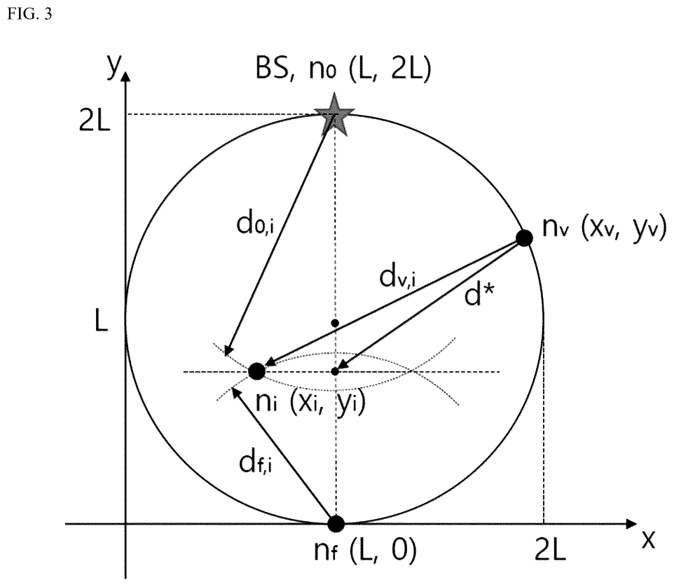

FIG. 3 is an example diagram illustrating the process of calculating the coordinates of all nodes for routing, according to the present invention.

Referring to FIG. 3, the first reference node, the second reference node, and the third reference node are determined at the circular boundary of the sensor field.

The diameter of the circular sensor field is determined based on the distance 2L between the first and second reference nodes and the center of the circular sensor field may be determined based on the midpoint between the first and second reference nodes.

For example, as shown in FIG. 3, when the first reference node is (L, 2L) and the second reference node is (L, 0), the circular sensor field may include a sensor field having the circular boundary of which the diameter is 2L and the center is (L, L).

The third reference node is a sensor node located closest to the circular boundary of the sensor field and is assumed to be located at the circular boundary thereof. The third reference node may be calculated therefrom through the following two simultaneous equations:

$$\{ \begin{matrix}{( {x}_{v} - L )}^{2} + {( {y}_{v} - L )}^{2} & = {L}^{2} \\ {( {x}_{v} - L )}^{2} + {( {y}_{v} - L )}^{2} & = {d}_{o , v}^{2}\end{matrix}$$

d_{o,v}² is a square value of the distance between the first and third reference nodes.

The other nodes may be obtained from the coordinates of the plurality of reference nodes using triangulation.

The x coordinates of the other nodes may be calculated according to Equation 7 below:

$${x}_{i} = \{ \begin{matrix}L + \sqrt{{d}_{f , i}^{2} - ( \frac{{d}_{f , i}^{2} - {d}_{0 , i}^{2}}{4 L} + L )} , & d * < {d}_{v , i} \\ L - \sqrt{{d}_{f , i}^{2} - ( \frac{{d}_{f , i}^{2} - {d}_{0 , i}^{2}}{4 L} + L )} , & d * \geq {d}_{v , i}\end{matrix} \qquad [ Equation 7 ]$$

Specifically, d* may be calculated according to Equation 8 below:

$$d *= \sqrt{{d}_{0 , i}^{2} - \frac{{d}_{0 , v}^{4}}{4 {L}^{2}} + {( L + \frac{{d}_{0 , i}^{2} - {d}_{f , i}^{2} - 2 {d}_{0 , v}^{2}}{4 L} )}^{2}} \qquad [ Equation 8 ]$$

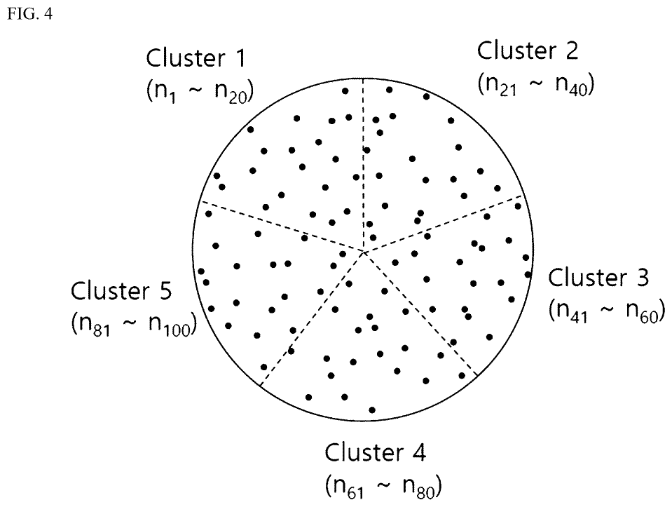

FIG. 4 is an example diagram illustrating the clustering process for routing, according to the present invention.

Referring to FIG. 4, the processor 110 may uniformly allocate a total of 100 sensor nodes included in the circular sensor field to each of 5 clusters.

Meanwhile, it is assumed that index numbers from 1 to 100 are allocated to the sensor nodes in FIG. 4 based on the distance information. The new index implies that the closer the index numbers are, the closer the corresponding sensor nodes are placed.

The processor 110 may uniformly allocate sensor nodes belonging to each cluster based on the preset number of clusters for each round. For example, as shown in FIG. 4, the processor 110 may allocate 20 sensor nodes to each cluster so that 100 sensor nodes are evenly allocated to 5 clusters.

The processor 110 may specify a head node within the cluster for each round. The processor 110 may set the head nodes of clusters to 1, 11, 21, 31, and 41, respectively, in the first round based on Equation 6 above. Likewise, in the second round, the head nodes of clusters may be set to 2, 12, 22, 32, and 42, respectively.

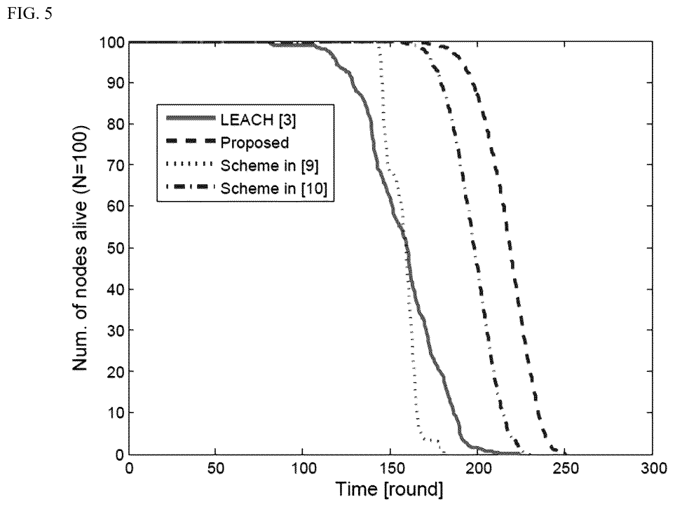

FIG. 5 is a graph comparing performances of methods for routing in wireless sensor networks, according to an embodiment.

FIG. 5 shows the lifetime of each routing method in terms of the number of sensor nodes operable without energy being completely consumed.

When the total number of usable sensor nodes is N and the lifetime of the routing method ends when energy is completely consumed and the sensor nodes are not operable, it can be seen that the routing method in this specification significantly increases the lifetime, compared to the LEACH method, which is an existing conventional technology.

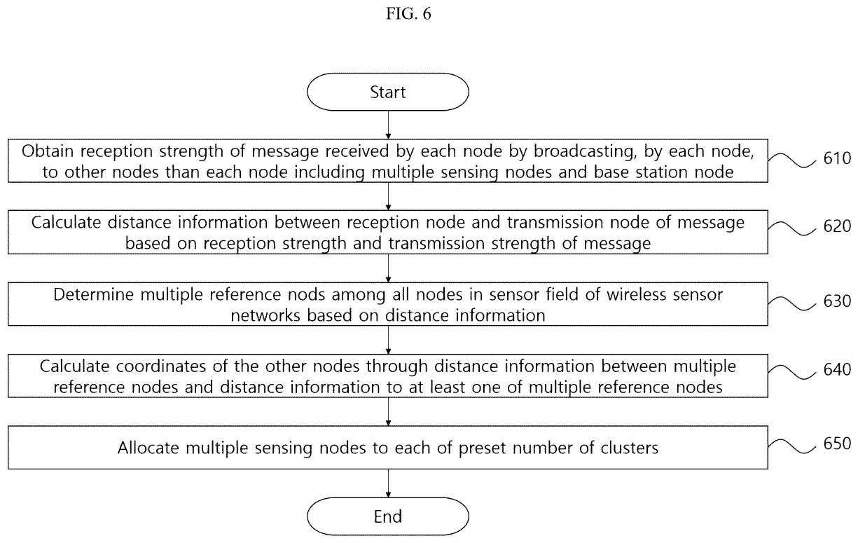

FIG. 6 is a flowchart of a method for deterministic cluster-based routing in wireless sensor networks, according to an embodiment.

Referring to FIG. 6, the method of FIG. 6 may be performed by the computing device 100 of FIG. 1.

First, the computing device 100 obtains the reception strength of the message received by each node by broadcasting, by each node, including a plurality of sensor nodes and a base station node, to the other nodes (610).

Thereafter, the computing device 100 calculates distance information between the transmission node and the reception node of the message based on the reception strength of the message and the transmission strength of the message (620).

Thereafter, the computing device 100 determines a plurality of reference nodes among all nodes in the sensor field of the wireless sensor networks, based on the distance information (630).

Thereafter, the computing device 100 calculates coordinates of the other nodes through distance information between the plurality of reference nodes and distance information to at least one of the plurality of reference nodes (640).

Thereafter, the computing device 100 allocates the plurality of sensor nodes to a preset number of clusters (650).

The foregoing detailed description is provided to facilitate a comprehensive understanding of the methods, devices and/or systems described herein. However, this is only an example and the present invention is not limited thereto.

In describing one embodiment, if it is determined that a detailed description of known technology related to the present invention unnecessarily obscures the gist of the embodiment, the detailed description is omitted.

The terms used in this specification, which are defined in consideration of functions in the present invention, may vary depending on the intention or custom of the user or operator. Therefore, the definition should be made based on the contents throughout this specification. The terms used in the detailed description are intended to describe only one embodiment and shall not limit the same.

Unless explicitly stated otherwise, singular forms include plural meanings.

Although representative embodiments of the present invention have been described in detail above, those skilled in the art will understand that various modifications can be made to the above-described embodiments without departing from the scope of the present invention. Therefore, the scope of the present invention should not be limited to the described embodiments but should be determined by the claims described below as well as equivalents to these claims.

### DESCRIPTION OF SYMBOLS

100: COMPUTING DEVICE
110: PROCESSOR
120: MEMORY

What is claimed is:

1. A method for deterministic cluster-based routing in wireless sensor networks, the method, performed by a computing device for routing in cluster-based wireless sensor networks, comprising the steps of:
broadcasting, by each of all nodes including a plurality of sensor nodes and a base station node, to other nodes than each node to obtain the reception strength of a message received by each node;
calculating distance information between a transmission node and a reception node of the message based on the reception strength of the message and the transmission strength of the message;
determining a plurality of reference nodes among all nodes arranged in a sensor field of the wireless sensor networks based on the distance information;
calculating coordinates of the other nodes through the distance information between the plurality of reference nodes and the distance information to at least one of the plurality of reference nodes; and
allocating the plurality of sensor nodes to each of a preset number of clusters.

2. The method of claim 1, wherein the step of determining the plurality of reference nodes comprises determining two nodes with the greatest distance among the distance information as a first reference node and a second reference node.

3. The method of claim 1, wherein the step of determining the plurality of reference nodes comprises determining the node, closest to a circular boundary of which the diameter is the first distance between the first and second reference nodes among the plurality of reference nodes and the center is the midpoint of the first distance, as a third reference node.

4. The method of claim 3, wherein the sensor field has the circular boundary determined based on the first reference node, the second reference node, and the third reference node.

5. The method of claim 3, wherein the step of determining the plurality of reference nodes comprises calculating the coordinates of the third reference node based on Equation 1 below:
$$\{ \begin{matrix}{x}_{v} & = L \pm \sqrt{{d}_{0 , v}^{2} - \frac{{d}_{0 , v}^{4}}{4 {L}^{2}}} \\ {y}_{v} & = 2 L - \frac{{d}_{0 , v}^{2}}{2 L}\end{matrix} \qquad [ Equation 1 ]$$
(xᵥ and yᵥ are coordinates of the third reference node, 2L is the diameter, and d_{0,v} is a distance between the first reference node and the third reference node.)

6. The method of claim 1, wherein the step of calculating coordinates of the other nodes comprises calculating coordinates of the other nodes based on triangulation with the plurality of reference nodes.

7. The method of claim 3, wherein the step of calculating coordinates of the other nodes comprises calculating the coordinates of the other nodes based on Equation 2 below:
$$\{ \begin{matrix}{x}_{i} & = \{ \begin{matrix}L + \sqrt{{d}_{f , i}^{2} - ( \frac{{d}_{f , i}^{2} - {d}_{0 , i}^{2}}{4 L} + L )} , & d * < {d}_{v , i} \\ L - \sqrt{{d}_{f , i}^{2} - ( \frac{{d}_{f , i}^{2} - {d}_{0 , i}^{2}}{4 L} + L )} , & d * \geq {d}_{v , i}\end{matrix} \\ {y}_{i} & = \frac{{d}_{f , i}^{2} - {d}_{0 , i}^{2}}{4 L} + L \\ d * & = \sqrt{{d}_{0 , i}^{2} - \frac{{d}_{0 , v}^{4}}{4 {L}^{2}} + {( L + \frac{{d}_{0 , i}^{2} - {d}_{f , i}^{2} - 2 {d}_{0 , v}^{2}}{4 L} )}^{2}}\end{matrix} \qquad [ Equation 2 ]$$
(xᵢ and yᵢ are coordinates of a sensor node corresponding to index i (hereinafter, referred to as the i^{th} node), 2L is the diameter, d_{0,i} is a distance between the first reference node and the i^{th} node, d_{f,i} is a distance between the second reference node and the i^{th} node, and d_{0,v} is a distance between the first reference node and the third reference node.)

8. The method of claim 1, wherein the step of allocating the plurality of sensor nodes comprises: allocating a new index to the sensor node based on the coordinates of the sensor node; and allocating the plurality of sensor nodes to a cluster based on the new index.

9. The method of claim 8, further comprising the step of specifying the order of time slots for the sensor nodes, wherein the order of time slots for the sensor nodes are specified based on the new index allocated to the sensor node.

10. The method of claim 8, further comprising the step of specifying a head node in the cluster, wherein the head node in each cluster is determined as one of the sensor nodes included in each cluster for each round based on Equation 3 below:
$$H = ( K - 1 ) G + ( R - 1 ) \% G + 1 \qquad [ Equation 3 ]$$
(H is an index of a node corresponding to the head node, k is a cluster number, G is the number of sensor nodes in the cluster, and r is a round number.)
